(19) United States
(12) Patent Application Publication
(10) Pub. No.: US 2001/0012765 A1
(43) Pub. Date: Aug. 9, 2001

(54) Method and arrangement for controlling transmitted power in a telecommunication system

(76) Inventors: Jonas Noreus, Varberg (SE); Mats Hogberg, Partille (SE); Per Lofving, Molndal (SE)

Correspondence Address: NIXON & VANDERHYE P.C., 8th Floor, 1100 North Glebe Road, Arlington, VA, 22201, US

(21) Appl. No.: 09/768,824

(22) Filed: Jan. 25, 2001

(30) Foreign Application Priority Data
Jan. 25, 2000 (SE) 0000203-0

(51) Int. Cl. H04B 1/00

(52) U.S. Cl. 455/69; 455/70; 455/522; 455/13.4; 455/127

(57) ABSTRACT

The invention relates to a method and an arrangement for controlling the total transmitted power in a mobile telephony system with a multiplicity of carrier waves, a multi-carrier system, in which system each carrier wave included has a defined output power at certain known points in time. The invention is characterized in that it comprises measuring the mean power (Pₘ) of the combined transmitted signal of the carrier waves in the system at points in time when the respective output power of the carrier waves is defined, calculating the desired mean power of the combined transmitted signal of the carrier waves in the system, and controlling the power of the combined transmitted signal to a desired mean power.

The method and arrangement according to the invention can also comprise supplying information about the number of carrier waves (N) in the system, which is utilized in calculating the desired mean power of the combined signal of the carrier waves in the system, and supplying information about the desired output power of each single carrier wave in the system, which is utilized in calculating the desired mean power of the combined signal of the carrier waves in the system.

### TECHNICAL FIELD

The present invention relates to a method and an arrangement for controlling transmitted power in a telecommunication system which uses a multiplicity of carrier waves, a so-called multi-carrier system.

### PRIOR ART

A technique which is often used in modern mobile telephony systems is so-called multi-carrier systems, in other words systems where a number of carrier waves of different frequencies is used for transmitting information within one and the same time interval. One of a number of advantages of such a system is that one and the same so-called transceiver (transmitter/receiver) can be modified for including a different number of carrier waves without the hardware needing to be changed, conversion to another number of carrier waves can be carried out completely by software.

In a mobile telephony system, there is a need, above all, to be able to detect the output power of the transmitter in a so-called base station and to be able to control the output power of the transmitter if it deviates from the desired value. In multi-carrier systems, this need exists for all the carrier waves which are used by the system. Each base station covers a certain area in the system, a so-called cell. Among the reasons for wanting to be able to measure the output power of the carrier waves, it may be mentioned that in a planning of a mobile telephony system, each carrier wave is allocated a certain permissible output power which, if it varies downward, can result in too short a range and, if it varies upward, can result in adjoining so-called cells in the mobile telephony system being interfered with.

U.S. Pat. No. 5,257,415 discloses an arrangement for detecting and controlling transmitted power in a multi-carrier system. The arrangement comprises a band-pass filter, the centre frequency of which sweeps over the complete frequency range which is applicable. The arrangement also comprises equipment for calculating the number of carrier waves within the applicable frequency range. This arrangement appears to provide a complex solution for the problem of detecting output power in a multi-carrier system.

U.S. Pat. No. 5,659,892 also discloses an arrangement for controlling output power in a multi-carrier system. This arrangement appears not to be capable of making measurements with full capacity utilization of the system, with the result that measurements reduce the capacity of the system. Furthermore, measurements cannot be made at the same time on all carrier waves, with the result that the capacity-reducing measurements must be carried out often to provide good precision, and conversely, if the capacity of the system is to be maintained, measurements can only be made rarely, which thus results in poor precision. The arrangement or method disclosed in this patent also appears to need a special test mode in the system, which requires specific software.

### DESCRIPTION OF THE INVENTION

The problem which is solved by the present invention is thus to produce an arrangement and a method for controlling transmitted power in a telecommunication system with a multiplicity of radio carrier waves, a so-called multi-carrier system, which method and arrangement make it possible to carry out measuring and subsequent controlling with full capacity utilization of the system without the need for separate test modes in the system.

This problem is solved in a multi-carrier system in which system each carrier wave included has a defined output power at certain known points in time, by measuring the mean power of the combined transmitted signal of the carrier waves in the system at points in time when the respective output power of the carrier waves is defined. The desired mean power of the combined transmitted signal of the carrier waves in the system is calculated, and the power of the combined transmitted signal is controlled to a desired mean power.

The invention also relates to an arrangement for controlling the total transmitted power in a mobile telephony system with a multiplicity of carrier waves, a multi-carrier system, in which system each carrier wave included has a defined output power at certain known points in time, which arrangement comprises means for measuring the mean power (Pₘ) of the combined transmitted signal of the carrier waves in the system at points in time when the respective output power of the carrier waves is defined, means for calculating the desired mean power of the combined transmitted signal of the carrier waves in the system, and means for controlling the power of the combined transmitted signal to a desired mean power.

The main variations in output power of the carrier waves are caused by variations of the hardware in the system which can arise, for example, due to ageing and temperature variations. Since the same hardware is utilized for all the carrier waves in a multi-carrier transceiver, the variations can therefore be considered to be of the same magnitude in the carrier waves over the applicable bandwidth, with the result that good precision in the measuring/controlling can be achieved by measuring the mean power of the combined transmitted signal of the carrier waves in the system at the points in time when the respective output power of the carrier waves is defined.

By measuring the mean power of the combined transmitted signal of the carrier waves in the system at the points in time when the respective output power of the carrier waves is defined, the need for a special measuring mode can be eliminated since the desired power is known by the system. Furthermore, the complexity in the equipment used for measuring can be considerably reduced at the same time as the need for calculations is kept to a minimum.

### DESCRIPTION OF THE FIGURES

The invention will be described in greater detail below with the aid of examples of embodiments and with reference to the attached drawings, in which:

FIG. 1 diagrammatically shows the different carrier waves in a multi-carrier system, and

FIG. 2 generally shows the principle behind the invention, and

FIG. 3 shows an example of how the output power of the signal is defined in a system with a constant signal envelope, GSM with GMSK modulation, and

FIG. 4 shows an example of how the output power of the signal is defined in a system with a varying signal envelope, GSM with EDGE system, and

FIGS. 5-7 show block diagrams of different systems in which the invention is applied.

### DETAILED DESCRIPTION OF THE INVENTION

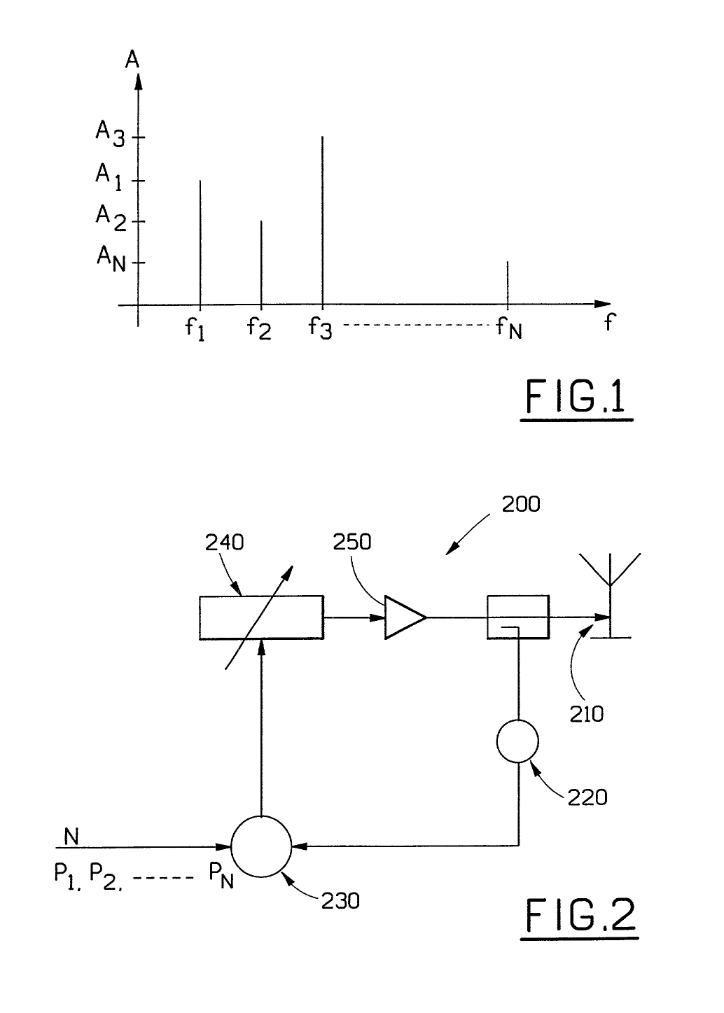

FIG. 1 diagrammatically shows how a number N of different carrier waves of different frequencies is included in a multi-carrier system. Each one of the carrier waves has an amplitude A. In FIG. 1, the amplitude of carrier wave number n has been designated by Aₙ. Each amplitude Aₙ corresponds to a power level Pₙ, and the combined transmitted power of the carrier waves in the system is made up of the sum of these powers, in other words ΣPₙ.

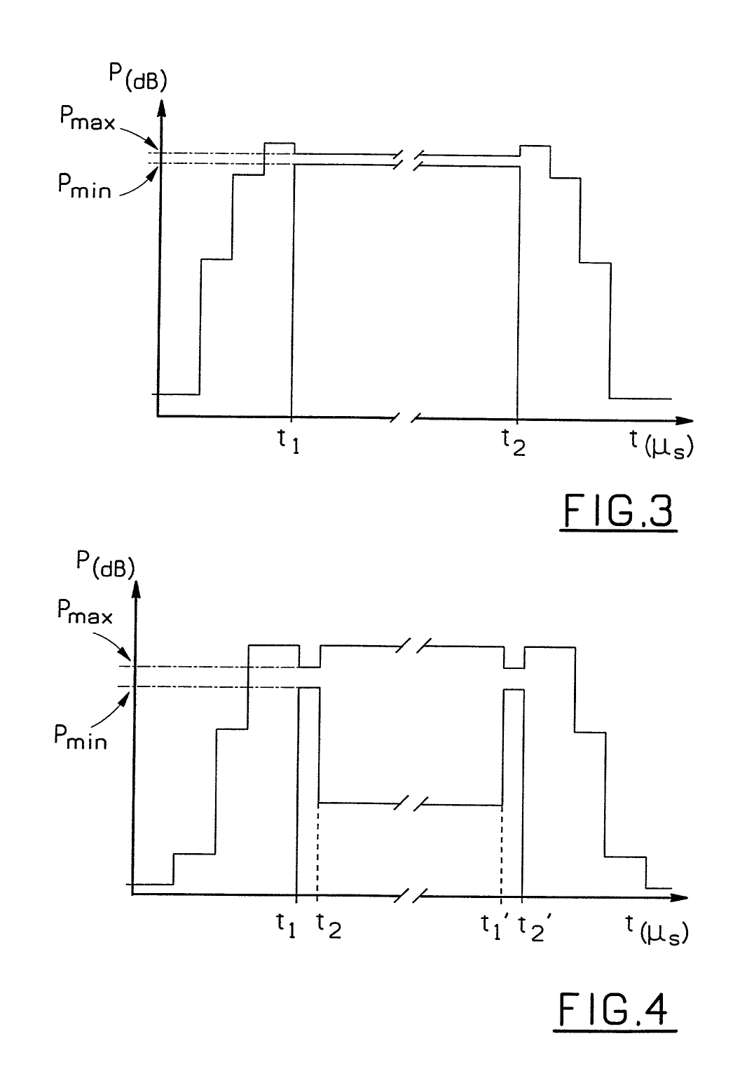

FIG. 2 shows a rough basic block diagram of a multi-carrier system 200 in which the present invention is applied. The system includes an antenna 210, an amplifier 250, a power detector 220, a transmitter attenuator 240 and an arrangement 230 for calculating the desired mean power of the combined transmitted signal of the carrier waves in the system. The way in which, for example, the amplifier 250 and the arrangement 230 for calculating the desired mean power are constructed will be described in greater detail further on in the description.

In principle, the system in FIG. 2 operates by the power detector 220 measuring the mean power at a certain point, ARP (antenna reference point), for the transmitted combined signal of all the carrier waves. In the arrangement 230, this mean power is compared with a corresponding desired mean power and, as a result of the comparison, the combined output power is controlled upward or downward with the aid of the transmitter attenuator 240.

The desired mean power can be known in advance in the arrangement 200, for example in the form of a stored table or, as an alternative, can also be calculated in the arrangement 200. The calculation is then suitably done by the arrangement 200 being supplied with information about the number N of carrier waves in the system and the desired output power P₁, P₂, P₃. . . Pₙ of each carrier wave, on the basis of which the combined mean power can be calculated.

So that the measuring and controlling according to the invention can be carried out with the desired precision, the measurement must be made at points in time when the output power of the carrier waves is defined. Such points in time are specified in the specifications of the respective system standard. An example of such a standard is GSM.

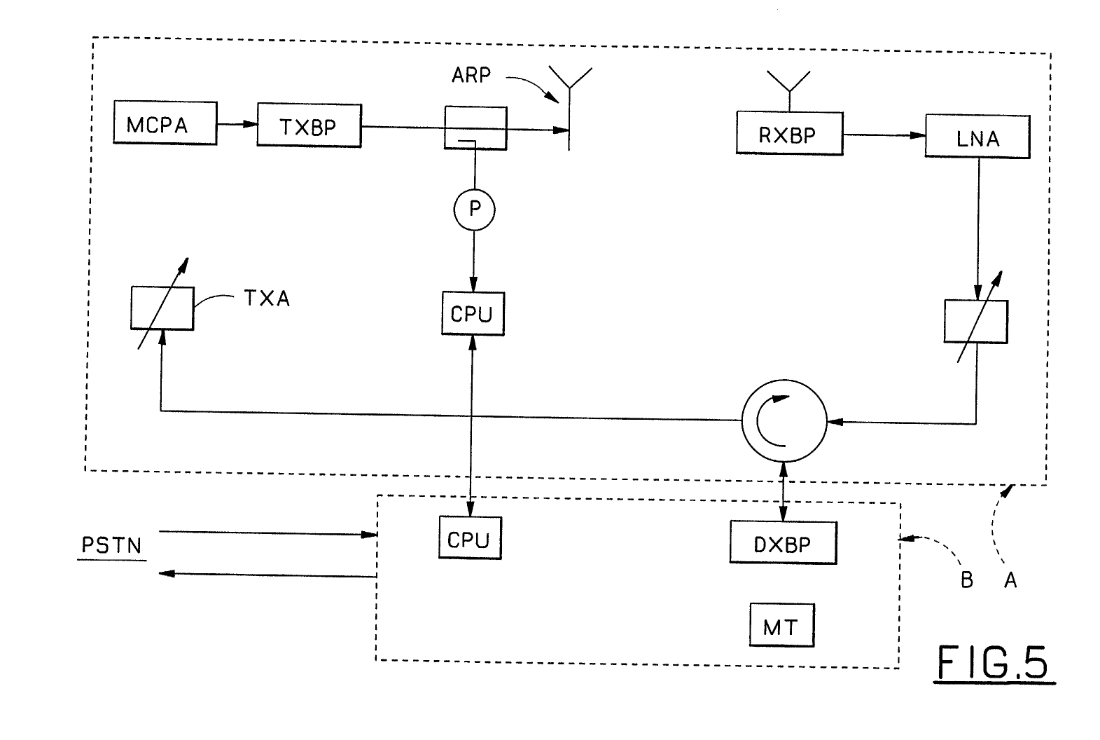

FIG. 3 shows the specification for a so-called “burst” in GMSK (Gaussian minimum shift keying) modulation which is used in the GSM system and which is an example of a system with a constant signal envelope. The picture has been taken from ETS 300 910, second edition, August 1997, page 35. Two frames are shown, an outer one which shows the maximum power of the signal as a function of time, and an inner one which shows the minimum level of the signal as a function of time.

As can be seen from FIG. 3, there is a time interval t₁-t₂, within which the output power of the signal must lie within a very narrow interval Pₘᵢₙ-Pₘₐₓ. In a system with a constant signal envelope, for example a GSM system with GMSK modulation, the measurement according to the invention is thus done within the time interval t₁-t₂ during which the output power of the signal is defined within very narrow limits, which makes it easy to see if the output power of the signal has varied from the desired value.

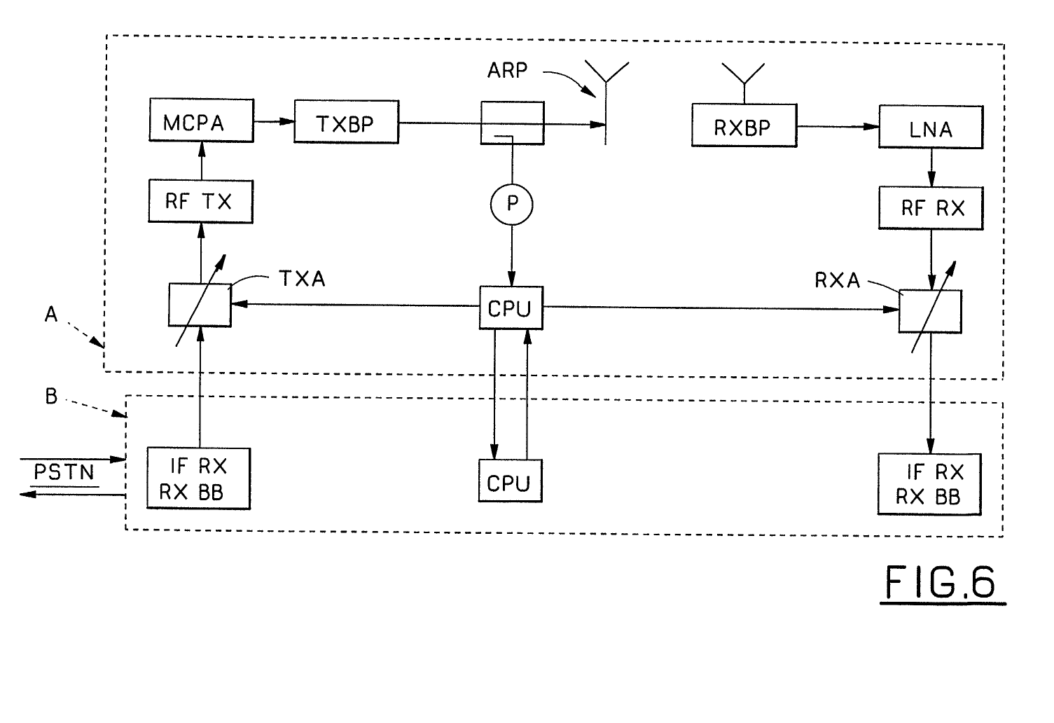

The fact that the invention utilizes points in time at which each carrier wave included has a defined output power, and measures the mean power of the combined transmitted signal of the carrier waves in the system has the result that the invention can be applied in a very large number of different mobile telephony systems. GSM with GMSK modulation has already been mentioned and, as examples of other systems where the invention can also be applied, systems of the DAMPS (IS136), GSM EDGE (enhanced data GSM evolution) and DAMPS EDGE type can be mentioned. To illustrate how the invention can be applied in a system with a varying signal envelope, GSM with EDGE modulation is shown in FIG. 4. The picture has been taken from the ETSI document Draft GSM 05.05 V8.0.0, page 61.

FIG. 4 also shows an outer and an inner frame and, like the corresponding frames in FIG. 3, the outer frame shows the maximum power of the signal as a function of time and the inner frame shows the minimum level of the signal as a function of time. In a system with a varying time envelope and EDGE modulation, there are two time intervals t₁-t₂, t_{1′}-t_{2′}, within which the output power of the signal is defined with a relatively narrow interval Pₘᵢₙ-P ₘₐₓ, as can be seen from FIG. 4. In a system with a varying signal envelope, for example a GSM system with EDGE modulation, the measurement according to the invention must thus be made within one of the two time intervals t₁-t₂, t_{1′}-t_{2′}.

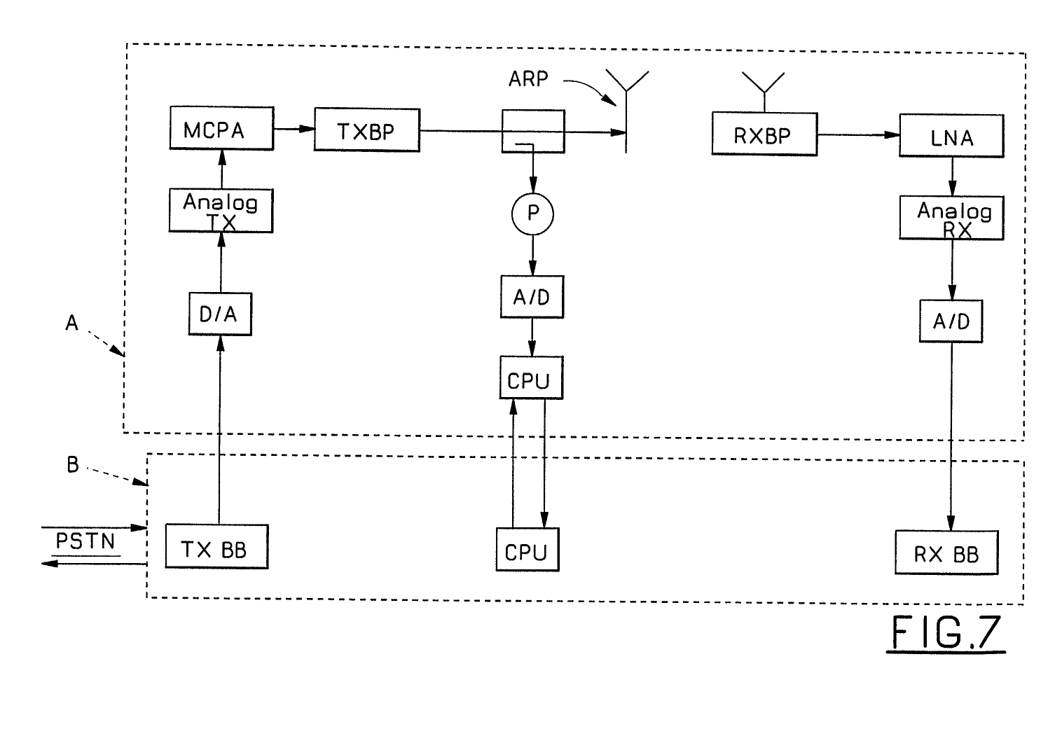

FIG. 2 shows a very rough basic block diagram of a system in which the invention is applied. FIGS. 5-7 show somewhat more detailed block diagrams of different systems in which the invention can be applied. The following designations will be used in FIGS. 5-7:

MCPA: Multi-Carrier Power Amplifier

TXBP: Transmit Band Pass filter

P: Power detector

RXBP: Receive Band Pass filter

LNA: Low Noise Amplifier

CPU: Central Processing Unit

DXBP: Duplex Band Pass Filter

TXA: Transmit Attenuator

RXA: Receive Attenuator

MT: Multi-carrier Transceiver

BB: Base band

IF: Intermediate Frequency

FIG. 5 shows a system which contains two main parts, one which is included in the base station itself, the square designated by B, and one part which is placed in or in association with the antenna, the square designated by A.

The radio interface between the part which is included in the base station itself and the part of the equipment which is placed in or in connection to the antenna is at RF level. The base station itself contains a CPU, DXBP and MT which together are included in BTS.

The equipment which has been placed in or in association with the antenna also includes a CPU. Apart from the RF interface, there is between the CPU in the base station and the CPU in the antenna part a digital information interface which is used for exchanging information for installation and/or calibration. As examples of such information, the frequency range, the number of carrier waves, the output power measured and synchronization signals can be named. When the invention is applied to this system, the CPU in the antenna part thus obtains information about the collective measured power of the carrier waves at ARP from the power detector P and information about the number of carrier waves and their respective desired output power at ARP from the CPU in the base station part. On the basis of this, the CPU in the antenna part can calculate the collective desired output power, compare it with the measured collective output power and control it with the aid of TXA. So that the system is in balance, there is also a RXA which is controlled to the same extent as TXA.

The system which is shown in FIG. 6 corresponds to the system in FIG. 5, with the difference that several of the radio parts (RF TX, RF RX) themselves have been placed in or in association with the antenna. In such a system, the RF interface in FIG. 5 is exchanged for a radio interface at intermediate frequency IF. To place several of the radio parts themselves in or in association with the antenna implies that the attenuators TXA and RXA can work at intermediate frequency, which provides better accuracy and simpler implementation.

FIG. 7 shows a system where all the radio parts have been placed in or in association with the antenna, which makes analogue receiver and transmitter attenuators superfluous since all controlling is done at base band level. The radio interface between BTS and the equipment in or in association with the antenna has been replaced in this system by a digital interface. The information interface between the two CPUs is retained.

The invention is not limited to the exemplary embodiments which have been described above but can be freely varied within the scope of the patent claims following. For example, the invention has above been described throughout as being applied in base stations in a mobile telephony system. It should be pointed out that the invention can also be applied in other parts of such a system, for example in different types of radio links which utilize multi-carrier techniques since these links can also require control of the output power because it is desired to change the number of carrier waves, or because of variations in the output power caused by, for example, ageing and temperature drift.

Controlling according to the invention can be done either on installation of a new system, continuously during operation of an existing system or when the number of carrier waves in the system is changed.

1. Method for controlling the total transmitted power in a mobile telephony system with a multiplicity of carrier waves, a multi-carrier system, in which system each carrier wave included has a defined output power at certain known points in time, which method is characterized in that it comprises the following:
measuring of the mean power (Pₘ) of the combined transmitted signal of the carrier waves in the system at points in time when the respective output power of the carrier waves is defined,
calculating the desired mean power of the combined transmitted signal of the carrier waves in the system,
controlling the power of the combined transmitted signal to a desired mean power.

2. Method according to claim 1, furthermore comprising supplying information about the number of carrier waves (N) in the system, which information is utilized in calculating the desired mean power of the combined signal of the carrier waves in the system.

3. Method according to claim 1 or 2, furthermore comprising supplying information about the desired output power of each single carrier wave in the system, which information is utilized in calculating the desired mean power of the combined signal of the carrier waves in the system.

4. Arrangement (200) for controlling the total transmitted power in a mobile telephony system with a multiplicity of carrier waves, a multi-carrier system, in which system each carrier wave included has a defined output power at certain known points in time, which arrangement is characterized in that it comprises the following:
means (220) for measuring the mean power (Pₘ) of the combined transmitted signal of the carrier waves in the system at points in time when the respective output power of the carrier waves is defined,
means (230) for calculating the desired mean power of the combined transmitted signal of the carrier waves in the system,
means (240) for controlling the power of the combined transmitted signal to a desired mean power.

5. Arrangement according to claim 4, furthermore comprising means for supplying information about the number of carrier waves (N) in the system to the means for calculating the desired mean power of the combined signal of the carrier waves in the system.

6. Arrangement according to claim 4 or 5, furthermore comprising means for supplying information about the desired output power of each single carrier wave in the system to the means for calculating the desired mean power of the combined signal of the carrier waves in the system.
